(19) United States
(12) Patent Application Publication
(10) Pub. No.: US 2010/0054286 A1
(43) Pub. Date: Mar. 4, 2010

(54) Semiconductor Diode Pumped Laser Using Heating-Only Power Stabilization

(76) Inventor: Christopher J. Gladding, Danville, CA (US)

Correspondence Address: LARIVIERE, GRUBMAN & PAYNE, LLP, 19 UPPER RAGSDALE DRIVE, SUITE 200, MONTEREY, CA, 93940, US

(21) Appl. No.: 12/447,380

(22) PCT Filed: Oct. 17, 2007
(86) PCT No.: PCT/US07/81623

§ 371 Date: Apr. 27, 2009

Related U.S. Application Data
(60) Provisional application No. 60/855,449, filed on Oct. 31, 2006.

(51) Int. Cl. H01S 3/10; H01S 3/13

(52) U.S. Cl. 372/21; 372/29.02

(57) ABSTRACT

A laser system such as a DPSS green laser uses a laser diode pump source that is specially selected so that the wavelength of diode source is centered around the optimal source wavelength, typically 808 nm, which produces the optimal green laser output from the system. Unlike prior systems in which the source wavelength is at 808 nm at typical ambient temperature of about 25° C., in the system disclosed, the source wavelength is at 808 nm at a temperature significantly higher than ambient, which may be as high as about 40° C. In this system optimum performance can be established and maintained in a broad temperature range such as 0˜50° C. using only a heating element adjacent to the diode laser pump source. No cooling is required. Cost, size, and power requirements of the system are therefore minimized.

### TECHNICAL FIELD

The present invention is a laser system in which a semiconductor laser diode pump source provides a laser source beam that pumps a gain medium (such as a laser crystal) to generate lasing in a certain wavelength, which lasing may then be altered in wavelength by nonlinear crystals to provide an output laser beam of a desired wavelength. Generically such lasers are called Diode Pumped Solid State Lasers, or DPSS lasers. Such DPSS lasers are used for applications in which the output is a green laser beam, typically at a wavelength of 532 nm. The present invention is particularly concerned with the manner in which the wavelength of the pump source beam is selected and stabilized against variation of wavelength with changes in ambient temperature, in order to optimize the output of the laser system.

### BACKGROUND ART

For many applications in various fields, lasers at a wavelength of 532 nm are used. Some applications for these so-called Green Lasers are interferometery, holography, printing, detection, inspection, florescence excitation, pointing and aiming among others. In the prior art, the typical method to generate laser light in the 532 nm n wavelength region is (i) to use as a source a pump diode laser source having a wavelength in the 808 nm region; (ii) to convert the 808 nm beam to a 1064 nm beam using a suitable laser crystal such as a Nd:YVO4 or Nd: YAG; (iii) and then convert the 1064 nm laser light to 532 nm using a non-linear crystal, typically KTP (Potassium Titanyl Phosphate).

A problem with 532 nm, diode based laser devices is that in, order for the device to have a reasonably stable output power, the pump laser source (typically an 808 nm laser diode) must be temperature stabilized to keep the lasing wavelength of the device stable. If it is not temperature stabilized then as the ambient temperature of the environment changes, the temperature of the pump laser source correspondingly changes, causing the lasing wavelength of the pump laser to change at a typical rate of 0.3 nm/deg C. The Nd:YVO4 laser crystal has a narrow absorption bandwidth and as the lasing wavelength of the pump source moves outside of the efficient absorption bandwidth of the Nd:YVO4 crystal the efficiency of conversion to 1064 nm and the subsequent conversion to 532 nm will drop considerably, causing a consequent drop in the output power of the system, at the desired 532 nm wavelength.

If an “ideal” pump source laser with a center frequency of exactly 808 nm at a temperature of 25 deg C. is used, then assuming a normal wavelength change of 0.3 nm/deg C. then a temperature change of +/−15° C. will change the lasing wavelength of the pump source such that the absorption efficiency of the Nd:YVO4 crystal may drop below 40% of its maximum value. Since typical pump source diodes have a wavelength tolerance specification of +/−3 nm then the temperature change required to shift the wavelength outside the Nd:YVO4 crystal absorption bandwidth may be as little as 6° C. This limits the operating temperature of the Green laser device to as little as 19° C. to 31° C. unless active temperature control is utilized.

The problems described above can be solved by controlling the temperature of the lasing semiconductor chip that forms the pump source. In the prior art, this is accomplished with a thermo electric cooler (TEC), a device which may heat or cool the pump source Laser semiconductor, along with the mounting for the chip, and sometimes also additional elements. Typically the TEC will temperature stabilize the pump laser to a normalized temperature of around 25° C. or the specific temperature at which the pump source laser chip emits the proper wavelength to maximize the absorption of the emitted laser light by the Nd:YVO4 (laser) crystal. To accomplish this, the TEC either heats or cools the pump source laser depending on the environmental temperature.

The disadvantage of this solution is that it adds considerable size and cost to the green laser device while also adding mechanical packaging complexity. For many “battery operated” applications the TEC solution also consumes too much electrical power to be usefully implemented. Alternate DPSS laser systems that do not utilize a TEC device for temperature stabilization such as “Green laser Pointers” are also well known. However they are useful only over a very limited operating temperature range, typically 20° C. to 30° C. Within this temperature range the output power is somewhat unstable and will vary dramatically. Beyond this temperature range the Green light output will drop to a level where it is no longer useful.

### DISCLOSURE OF THE INVENTION

In laser systems of the type described above, it would be preferable to control the temperature of only the pump source laser chip, and as little of the mechanical packaging as possible, and to exercise this control only under limited circumstances. In this manner, much less electrical power would be consumed. The present invention provides a system that utilizes a very small, heating-only element, typically a resistive element, mounted as close as possible to the pump laser chip where the thermal mass is low. No cooling element is necessary. This is in contradistinction to the traditional method of maintaining a constant temperature of the pump source package by means of a heating and cooling element such as a thermoelectric cooler (TEC). In order to utilize this scheme, the laser diode pump source is specially selected so that the wavelength of the output beam is centered around 808 nm, not at typical ambient temperature of about 25° C., but at a temperature significantly higher than ambient, which in selected embodiments of the invention may be as high as about 40° C.

### BRIEF DESCRIPTION OF THE DRAWINGS

FIG. 1 is a schematic drawing of a laser system in accordance with aspects of the present invention.

FIG. 2 is a graph of the variation of the output wavelength of a diode source laser as a function of the operating temperature of the laser chip.

FIG. 3 shows another embodiment of the invention with an alternate feedback loop for controlling the laser diode source.

FIG. 4 shows yet another embodiment of the invention with a different feedback loop for controlling the laser diode source.

### MODES FOR CARRYING OUT THE INVENTION

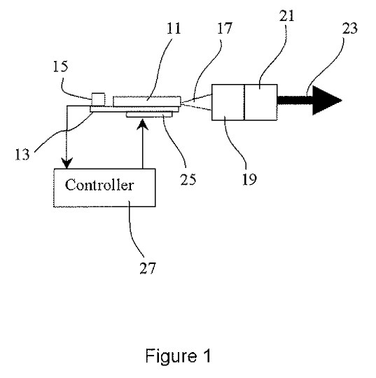

In FIG. 1 there is shown a laser system in which a laser pump source is a laser diode chip 11. As will be explained in more detail later, for use in a system to produce an output beam of green laser light, laser pump source 11 should produce a laser beam at a nominal wavelength of 808 nm. In prior art systems this wavelength is produced when the laser source is operated at a temperature of about 25° C.

Laser pump source 11 is mounted on a sub-mount 13 in the manner conventional to DPSS lasers as is well-known in the art. A temperature monitor 15 is also mounted on the laser sub-mount 13, as close to the pump source 11 as practical, in order to monitor the temperature of chip 11. Typically, monitor 15 may be a thermistor as is well known in the art, which directly indicates the temperature of laser mount 13, which is itself in a known relationship to the temperature of chip 11. An output laser beam 17, from chip 11, nominally at a wavelength of 808 nm, is directed into a laser crystal 19, which converts the wavelength of beam 17 from 805 nm to 1064 nm, and directs the converted beam into another crystal 21. Crystal 19 may be of the Nd:YVO₄ type (Neodymium Doped Yttrium Orthvanadate), available from various commercial sources. Crystal 21 may be of the KTP type (Potassium Titanium Oxide Phosphate), also commercially available.

A heating element 25 is positioned as close to laser pump source chip 11 as is practical. The heating element 25 is selected to be small in size, provide adequate heat output to maintain the temperature of laser chip 11 in the range of about 25° C. to 40° C. and use as little electrical current as possible. An appropriate element may be a thick film or thin-film resistive device, which is heated by a current passing through it. A controller 27 sends current to heating element 25 in response to feedback signals received from the monitor 15, thus providing closed-loop control of the wavelength of the output beam from laser pump source 11. Controller 27 is comprised of circuits, algorithms and/or software designed for compatibility with laser pump source 11 and heating element 25. The laser pump source 11 is itself conventionally driven by a controller (not shown) in a well-known manner that controls the current of the laser pump source, and for some applications it may be desirable to integrate the circuitry of controller 27 with that of the current controller for laser pump source 11.

In a diode pumped laser system configured as in FIG. 1, the output wavelength of pump source laser diode chip 11 is a function of the temperature of the chip. Variations in that temperature produce associated variations in the wavelength of the nominally 808 nm beam, which is the input to crystals 19 and 21. An important feature of the system, which is critical to aspects of the present invention, is that the output power of the laser crystal will drop off from its maximum as the input wavelength to the crystal shifts away from 808 nm in either direction, for example due to temperature variation.

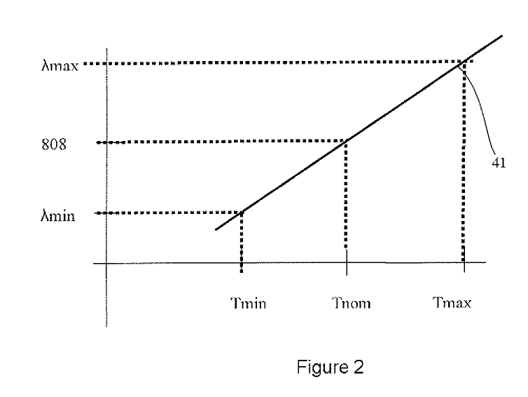

Shown in FIG. 2 is the wavelength curve 41 of a pump laser having a nominal output wavelength of 808 nm, and which follows a curve (a line, in this case) such as that shown in FIG. 2, as the operating temperature varies. This beam will be the input to laser crystal 19 that produces an output beam at 1064 nm, which is then doubled in crystal 21 to produce the ultimate green output beam at a wavelength of 532 nm.

In FIG. 2, λₘₐₓ represents the maximum wavelength presented as input to the laser crystal 19, which will insure that the laser crystal will emit laser light of the desired power. Wavelengths above λₘₐₓ will produce an output beam of insufficient power. Now, if one knows the maximum temperature at which the pump laser is expected to operate in the system (which will be called Tₘₐₓ) then one has identified the point (Tₘₐₓ, λₘₐₓ) on the curve in FIG. 2. Since the shape of the curve is known to be a straight line, this is sufficient to identify Tₙₒₘ, the nominal operating temperature that should be chosen at which the pump laser will produce an output of 808 nm wavelength. Thus, if the pump laser is operated in the temperature range Tₙₒₘ<T<Tₘₐₓ the wavelength of the pump laser will allow the laser crystal to produce sufficient output power, without the necessity of any heating or cooling of the laser chip 11.

In accordance with aspects of the invention, it is now required to select Tₙₒₘ for the system. This is done by first noting that in practical applications, Tₘₐₓ should be about 55 deg C. As discussed earlier, the frequency of the Laser Power Curve falls off its maximum when the input wavelength to crystal 19 changes, the rate of this change being about 0.3 nm/deg C. Thus, if Tₙₒₘ is chosen to be about 40 Deg C., then at 55 Deg C, the wavelength of the pump laser will be [55−40] Deg C.×0.3 nm/Deg C.=4.5 nm above 808 nm. At this input wavelength the power output of the laser crystal drops to below 40% of its maximum power output, which is the level deemed insufficient for practical applications. This confirms the choice of Tₙₒₘ=40 Deg C. as appropriate to allow operation up to Tₘₐₓ=55 Deg C.

Operation of the system at temperatures below Tₙₒₘ is described in a similar manner based on the same Laser Wavelength curve of FIG. 2. From the curve, one can deduce a minimum temperature Tₘᵢₙ, such that for Tₘᵢₙ<T<Tₙₒₘ the wavelength of the pump laser will be in the range to insure that the laser crystal will provide appropriate power output. It is evident that Tₘᵢₙ=Tₙₒₘ−15 Deg C. So for the case above, where Tₘₐₓ=55 Deg C., Tmin=25 Deg C. It should be noted that due to tolerances in the pump lasers, the wavelength may vary in such a way that the upper limit is reached at a temperature lower than 55 Deg C., and/or the lower limit is at a temperature higher than 25 Deg C., but these variances can be accounted for simply by small adjustments to the drive current of the pump laser.

In prior art systems of this type, the basic pump laser diode chip 11 is selected to generate its optimal lasing wavelength (i.e. the wavelength that is ideally matched to the peak absorption frequency of the Laser crystal, Nd:YVO4 in the above example) at an operating temperature of about 25° C., the usual ambient temperature at which the device will be operated. Then chip 11 is heated and cooled to maintain this temperature when the ambient temperature changes. In contradistinction, in accordance with aspects of the present invention, the basic pump laser chip 11 is selected to generate its optimal lasing wavelength at a higher temperature than 25° C.; in the example discussed above, Tₙₒₘ is selected to be about 40° C. The result is that it will never be necessary to cool laser diode chip 11 in order to maintain the appropriate 808 nm wavelength as the ambient temperature changes within the expected range. So no cooling mechanism need be utilized, but only a simple heating element. Because of the small size and low power requirements of the elements of a system in accordance with the invention, the pump laser chip may be mounted into a small package, such as a 9 mm, 4 pin TO can, along with monitor 15 and heating element 25.

If the temperature of chip 11 is between about 25° C. and 55° C. then the heater element typically need not be turned on. The laser wavelength of chip 11 will exhibit some change in this range, but the corresponding variation in 532 nm (green) laser power output 23 may be reasonably compensated by adjusting the operating current to the pump source 11 in a known manner. However, if the chip temperature drops to a range 532 nm where reasonably stable laser power cannot be maintained by increasing the operating current for chip 11, which would occur at a temperature of 25° C. or less, then heater 25 is turned on to warm chip 11 up to a temperature where reasonable green laser power output is maintained. This operation may be controlled by monitoring either the pump source temperature by means of the integrated thermistor, or by monitoring the power level of pump power within the absorption bandwidth of the Nd:YVO4 laser crystal 19, or by monitoring the power level of the 532 nm green light, or any combination of the above.

In this exemplary embodiment, the source laser diode 11 is selected to generate the optimal wavelength (808 nm in this example) at an operating temperature of 40° C., which is significantly higher than 25° C., the usual operating temperature of these kinds of devices. Of course, selection of a source laser diode that generates the optimal wavelength at lower operating temperature, perhaps as low as 30° C. which is still significantly higher than an operating temperature of 25° C., would be in accordance with the principles of the invention. But in operation, a system using this latter source laser diode would not yield equivalent performance at higher operating temperatures, with the output possibly becoming unacceptable as temperature nears 50° C.

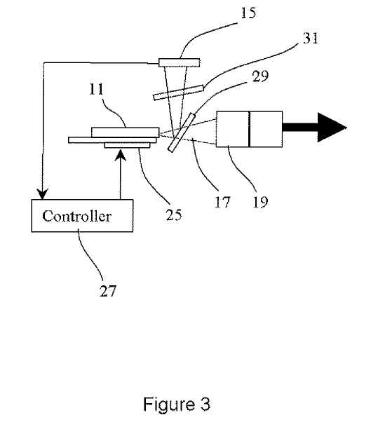

FIG. 3 illustrates an embodiment of the invention in which the output of laser pump source 11 is monitored to detect the optical power within the absorption bandwidth of laser crystal 19, which in the embodiment discussed above is centered around 808 nm. In FIG. 3, diode pump 11 emits beam 17 into crystal 19 as described above in connection with FIG. 1. However, in this embodiment a beam splitter 29 is used to deflect a small portion of pump laser beam 17 into a band pass filter 31, whose pass band corresponds to the absorption bandwidth of laser crystal 19. The beam is detected by a monitor 15, such as a common photodiode, which responsively outputs an electrical signal to a controller 27. Controller 27 then controls heater 25, in the same manner as described above in connection with FIG. 1. Alternately, if source laser diode 11 includes as part of its structure a back-facet photodiode (not shown) then this photodiode, appropriately filtered, can be used to provide the required signal to controller 27.

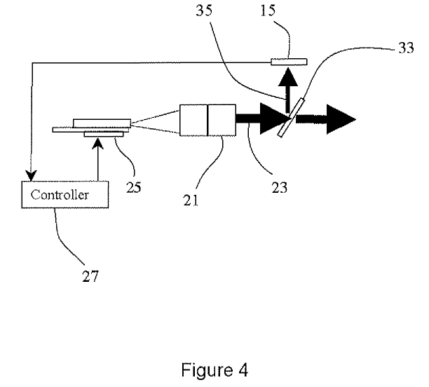

In another embodiment illustrated in FIG. 4 there is shown a system of the general type illustrate in FIG. 1. However, in the embodiment of FIG. 4, output beam 23 from crystal 21 is directed to a beam splitter 33, where a fraction of the 532 nm energy of beam 35 is deflected to a monitor 15, such as a common photodiode, which outputs an electrical signal indicative of the signal 35 to controller 27. Controller 27 then controls heater 25, in the same manner as described above in connection with FIG. 1 in order to maintain the output power of the device in the desired range.

There are a number of advantages of a laser system in accordance with the invention as compared to prior art systems. Since the pump laser is at its ideal wavelength at say 40° C., this method is a simple way to keep the laser within a suitable wavelength range to match to the laser crystal (Nd:YVO4) absorption range. Since no cooling is required, this allows simple design for both mechanical and electrical parameters and will allow miniaturization of the Green laser. Note that heating is only required if the package temperature drops below approximately 25° C. and since the heat source can be mounted very close to the pump laser chip, a reasonably low power consumption can be achieved for an operating temperature of 0° C. to 50° C. Cooling, which typically requires higher power levels than heating, is never required for the laser chip or any other part of the system.

### INDUSTRIAL APPLICABILITY

The present invention is industrially applicable to laser systems. More specifically, the present invention is industrially applicable to diode pumped solid state lasers. The present invention optimizes laser system output by stabilizing the temperature of the laser pump source.

What is claimed:

1. A laser system comprising:
a laser diode source emitting a source laser beam; and
conversion means to convert said source laser beam into an output laser beam of different characteristics than said source laser beam, the output laser beam being optimized when the wavelength of the source laser beam is centered about a predetermined optimal wavelength;
wherein the source laser beam is centered about said predetermined optimal wavelength when the laser diode source is operated at an operating temperature significantly higher than 25° C.

2. A laser system as in claim 1 further including heating means to raise the temperature of the source laser diode, the heating means having no capability to lower the temperature of the source laser diode.

3. A laser system as in claim 2 in which said predetermined optimal wavelength is manifest when the laser diode source is operated at an operating temperature higher than about 35° C.

4. A laser system as in claim 3, further comprising temperature monitoring and control means to measure the operating temperature of said laser diode source and to send a feedback signal to said heating means responsive to variations in said operating temperature.

5. A laser system as in claim 4 in which said conversion means functions to convert the source laser beam into an output laser beam having a wavelength different than the wavelength of said source laser beam.

6. A laser system as in claim 5 wherein said conversion means comprises:
a first crystal for converting the source laser beam into an intermediate laser beam of an intermediate wavelength, and
a second crystal positioned to receive said intermediate laser beam from said first crystal and to convert said intermediate laser beam into an output laser beam from said system of a desired output wavelength.

7. A laser system as in claim 6 in which the wavelength of the source laser beam is 808 nm, the wavelength of the intermediate laser beam is 1064 nm, and the output laser beam from said system is 532 nm.

8. A laser system as in claim 3 further comprising wavelength monitoring means to monitor the wavelength of the source laser diode beam and to send a feedback signal to said heating means responsive to variations in said wavelength.

9. A laser system as in claim 8 in which said conversion means functions to convert the source laser beam into an output laser beam having a wavelength different than the wavelength of said source laser beam.

10. A laser system as in claim 9 wherein said conversion means comprises:
a first crystal for converting the source laser beam into an intermediate laser beam of an intermediate wavelength, and
a second crystal positioned to receive said intermediate laser beam from said first crystal and to convert said intermediate laser beam into an output laser beam from said system of a desired output wavelength.

11. A laser system as in claim 10 in which the wavelength of the source laser beam is 808 nm, the wavelength of the intermediate laser beam is 1064 nm, and the output laser beam from said system is 532 nm.

12. A laser system as in claim 3 further comprising energy monitoring means to monitor the energy level of the output laser beam from said system within a predetermined wavelength interval, and to send a feedback signal to said heating means responsive to variations in said energy level.

13. A laser system as in claim 12 in which said conversion means functions to convert the source laser beam into an output laser beam having a wavelength different than the wavelength of said source laser beam.

14. A laser system as in claim 13 wherein said conversion means comprises:
a first crystal for converting the source laser beam into an intermediate laser beam of an intermediate wavelength, and
a second crystal positioned to receive the intermediate laser beam from said first crystal and to convert said intermediate laser beam into an output laser beam from said system of a desired output wavelength.

15. A laser system as in claim 14 in which the wavelength of the source laser beam is 808 nm, the wavelength of the intermediate laser beam is 1064 nm, and the output laser beam from said system is 532 nm.
Table of Claims

| | | | | | | | Feature |
|---|---|---|---|---|---|---|---|
| 1 | | | | | | | Source with displaced wavelength |
| | 2 | | | | | | Heating only to control source |
| | | 3 | | | | | Source operating temp about 40 Deg |
| | | | 4 | | | | With temp monitoring feedback |
| | | | | 5 | | | With wavelength multiplier |
| | | | | | 6 | | Multiplier = two crystals |
| | | | | | | 7 | Specific wavelengths |
| | | | 8 | | | | With wavelength feedback |
| | | | | 9 | | | With wavelength multiplier |
| | | | | | 10 | | Multiplier = two crystals |
| | | | | | | 11 | Specific wavelengths |
| | | | 12 | | | | With energy level feedback |
| | | | | 13 | | | With wavelength multiplier |
| | | | | | 14 | | Multiplier = two crystals |
| | | | | | | 15 | Specific wavelengths |
